(19) United States
(12) Patent Application Publication
(10) Pub. No.: US 2020/0333804 A1
(43) Pub. Date: Oct. 22, 2020

(54) DRONE LANDING SYSTEM AND METHOD

(71) Applicant: GM GLOBAL TECHNOLOGY OPERATIONS LLC, DETROIT, MI (US)

(72) Inventors: Joel G. Toner, Imlay City, MI (US); Teresa J. Rinker, Royal Oak, MI (US); Prachi Joshi, Troy, MI (US); Niccolo Jimenez, Royal Oak, MI (US); Jinzhu Chen, Troy, MI (US); Fan Xu, Oakland Township, MI (US); Daniel Bouie, Sunnyvale, CA (US)

(21) Appl. No.: 16/387,684

(22) Filed: Apr. 18, 2019

(51) Int. Cl. G05D 1/06; B64C 39/02; G08G 5/00; B64F 1/22

(52) U.S. Cl. CPC G05D 1/0684; B64C 39/024; B64C 2201/18; B64F 1/22; B64C 2201/145; G08G 5/0069

(57) ABSTRACT

A drone landing method and system are provided. The method includes illuminator configured to determining a position and a speed of a vehicle based on vehicle information received via wireless communication, synchronizing the speed of the drone to the speed of the vehicle and maneuvering a drone to a position above a landing point on the vehicle based on the vehicle information, and landing the drone at the landing point of the vehicle.

### INTRODUCTION

Apparatuses and methods consistent with exemplary embodiments relate to drones. More particularly, apparatuses and methods consistent with exemplary embodiments relate to vehicle integrated drones.

### SUMMARY

One or more exemplary embodiments provide a drone landing method and drone landing system. More particularly, one or more exemplary embodiments provide a drone landing method and drone landing system configured to a drone based on vehicle information.

According to an aspect of an exemplary embodiment, a drone landing method is provided. The method includes determining a position and a speed of a vehicle based on vehicle information received via wireless communication; maneuvering a drone to a position above a landing point on the vehicle based on the vehicle information and synchronizing the speed of the drone to the speed of the vehicle; and landing the drone at the landing point of the vehicle.

The method may include receiving the vehicle information from the vehicle via one or more from among cellular, Wi-Fi and Bluetooth Communication, and the vehicle information may be information provided by one or more from among an inertial measurement unit, a global positioning device at the vehicle, a speedometer at the vehicle, and a speed sensor at the vehicle.

The landing the drone may include tracking the landing point of the vehicle via an image taken by a camera at the drone and landing the drone based on the tracking.

The landing point may include a symbol to be tracked by the drone.

The landing point may include one or more landing indicators, from among a lighted pattern, a programmed lighting sequence or configuration, and a reflector, to be tracked by the drone during the landing.

The landing the drone may include receiving a signal at the drone emitted by a beacon at the vehicle, determining the landing point of the vehicle via the signaling and landing the drone based on the signaling.

The method may include moving the landing point via a rail mechanism to catch the landing drone.

The method may include activating a latch to capture the drone.

The method may include storing the drone by activating a cover to cover the landing point or moving the landed drone into a drone storage location.

According to an aspect of an exemplary embodiment, a drone landing system is provided. The system includes at least one memory storing computer executable instructions; and at least one processor configured to read and execute the computer executable instructions. The computer executable instructions causing the at least one processor to determine a position and a speed of a vehicle based on vehicle information received via wireless communication, maneuver a drone to a position above a landing point on the vehicle based on the vehicle information and synchronize the speed of the drone to the speed of the vehicle, and land the drone at the landing point of the vehicle.

The system may further include a communication device configured to transmit the vehicle information from the vehicle, and the vehicle information may be information provided by one or more from among an inertial measurement unit, a global positioning device at the vehicle, a speedometer at the vehicle, and a speed sensor at the vehicle.

The controller may be further configured to land the drone by tracking the landing point of the vehicle via an image taken by a camera at the drone and landing the drone based on the tracking.

The landing point may include a symbol to be tracked by the drone.

The landing point may include one or more landing indicators, from among a lighted pattern, a programmed lighting sequence or configuration, and a reflector, to be tracked by the drone during the landing.

The system may include a beacon at the vehicle configured to emit a signal that is detectable by the drone, and the controller may be configured to determine the landing point of the vehicle based on the signal emitted by the beacon and control to land the drone based on the signaling.

The landing point may include tracks or rails configured to move the landing point forward, backward, left and right with respect to the vehicle.

The landing point may include a latch configured to latch onto the drone as it is landing.

The latch may include a rotating magnetic latch.

The controller may be further configured to control to store the drone by activating a cover to cover the landing point or control to move the landed drone into a drone storage location.

Other objects, advantages and novel features of the exemplary embodiments will become more apparent from the following detailed description of exemplary embodiments and the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 shows a block diagram of a drone landing system according to an exemplary embodiment;

FIGS. 2A and 2B show illustrations of drone landings according to aspects exemplary embodiments; and

FIG. 3 shows a drone landing method according to an aspect of another exemplary embodiment.

### DETAILED DESCRIPTION

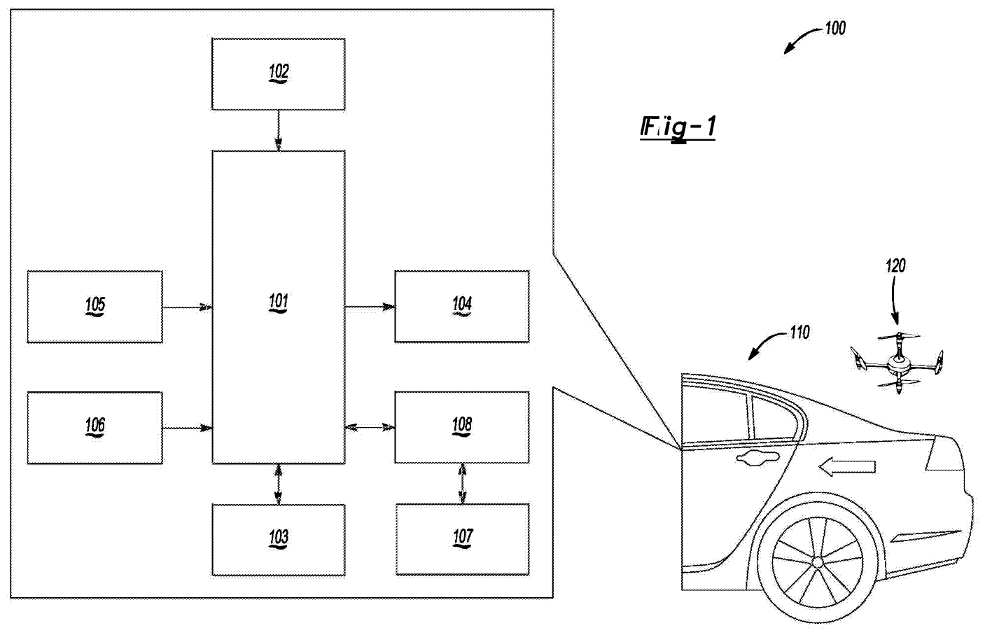

A drone landing system and method will now be described in detail with reference to FIGS. 1-3 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Drones are becoming widely used and provide advantages including the ability to land and take off vertically, a small size for portability and easy storage, and simplified or automated flight control systems that allow an operator to focus on another function that may be performed by the drone. Drones may perform functions such as photography, reconnaissance, transportation, cargo shipment, wireless communications, etc. Due to the versatility of the drone, they are being considered for use in conjunction with other types of vehicle, for example cars, trucks, SUVs, etc. However, the integration and deployment of drones with vehicles requires the ability to take off and land from moving vehicles as well as the ability to efficiently stow the drones in the vehicle.

To address the above issues, a drone landing system, according to an exemplary embodiment, may include maneuvering a drone to land at a vehicle by using vehicle information. Moreover, a drone landing system, according to an aspect of another exemplary embodiment, may include tracking the landing point via one or more communication devices or sensors. Further still, the drone landing system may include storage and/or latching mechanism configured to capture a landing drone.

FIG. 1 shows a block diagram of a drone landing system 100 according to an exemplary embodiment. As shown in FIG. 1, the drone landing system 100, according to an exemplary embodiment, includes a controller 101, a power supply 102, a storage 103, an output 104, a sensor 105, a user input 106, a drone 107, and a communication device 108. However, the drone landing system 100 is not limited to the aforementioned configuration and may be configured to include additional elements and/or omit one or more of the aforementioned elements. The drone landing system 100 may be implemented as part of a vehicle, as a standalone component, or as a hybrid between an on vehicle 110 and off vehicle device such as one or more drones 120.

The controller 101 controls the overall operation and function of the drone landing system 100. The controller 101 may directly or indirectly control one or more of a power supply 102, a storage 103, an output 104, a sensor 105, a user input 106, a drone 107, and a communication device 108, of the drone landing system 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the power supply 102, the storage 103, the output 104, the sensor 105, the user input 106, the drone 107, and the communication device 108 of the drone landing system 100. The information may be sent and received via a bus or network, or may be directly read or written to/from one or more of the power supply 102, the storage 103, the output 104, the sensor 105, the user input 106, the drone 107, and the communication device 108 of the drone landing system 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet.

The power supply 102 provides power to one or more of the storage 103, the output 104, the sensor 105, the user input 106, the drone 107, and the communication device 108, of the drone landing system 100. The power supply 102 may include one or more from among a battery, an outlet, a capacitor, a solar energy cell, a generator, a wind energy device, an alternator, etc. The power supply 102 may be configured to charge the drone 107.

The storage 103 is configured for storing information and retrieving information used by the drone landing system 100. The storage 103 may be controlled by the controller 101 to store and retrieve information received from one or more sensors 105 as well as computer or machine executable instructions. The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions. The storage may store vehicle information including one or more from among vehicle speed, vehicle location, vehicle route, vehicle destination and drone information including one or more from among drone speed, drone location, and drone energy level.

The output 104 outputs information in one or more forms including: visual, audible and/or haptic form. The output 104 may be controlled by the controller 101 to provide outputs to the user of the drone landing system 100. The output 104 may include one or more from among a speaker, audio, a display, a centrally-located display, a head up display, a windshield display, a haptic feedback device, a vibration device, a tactile feedback device, a tap-feedback device, a holographic display, an instrument light, an indicator light, etc.

The output 104 may output notification including one or more from among an audible notification, a light notification, and a display notification. The notification may include information notifying of the activation or deactivation of the drone landing system 100. The output 104 may also display image and information provided by one or more sensors 105. For example, the output 104 may display image information provided

The sensor 105 may include one or more from among a vehicle speed sensor, a speedometer, an inertial measurement unit, a camera, a video camera, an ultrasonic sensor, a radar, and, an imaging sensor. The sensor 105 may be provide information to the controller used to track the location of drone 107 with respect to the vehicle and generate tracking information. The tracking information may be used by the drone 107 or the vehicle 110 to align the drone with the landing point of the vehicle and synchronize the speed of the drone 107 with the speed of the vehicle 110.

The user input 106 is configured to provide information and commands to the drone landing system 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a touchpad, etc. The user input 106 may be configured to receive a user input to acknowledge or dismiss the notification output by the output 104. The user input 106 may also be configured to receive a user input to initiate the drone landing system 100, launch the drone 107 and/or store the drone 107.

The drone 107 may be a vertical take off and landing vehicle including one or more propulsion devices such as propellers. The drone 107 may communicate and send/receive information to/from a controller 101 on the vehicle 110 via a communication device 108. The information may include one or more from among image information of images taken by the drone, location information of the drone, drone speed, drone altitude, remaining energy of the drone, and information corresponding to drone sensors or functions.

The communication device 108 may be used by drone landing system 100 to communicate with several types of external apparatuses according to various communication methods. The communication device 108 may include various communication modules such as one or more from among a telematics unit, a broadcast receiving module, a beacon, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to an aspect of an exemplary embodiment, the controller 101 of the drone landing system may be configured to determine a position and a speed of a vehicle based on vehicle information received via wireless communication, maneuver a drone to a position above a landing point on the vehicle based on the vehicle information and synchronize the speed of the drone to the speed of the vehicle, and land the drone at the landing point of the vehicle. In one example, wherein the controller may be configured to determine the landing point of the vehicle based on the signal emitted by the beacon and control to land the drone based on signaling from a beacon.

In another example, the controller may be further configured to control to store the drone by activating a cover to cover the landing point or control to move the landed drone into a drone storage location. The drone storage location may be a box or compartment and the landing point may include a conveyor device configured to move the drone into the compartment.

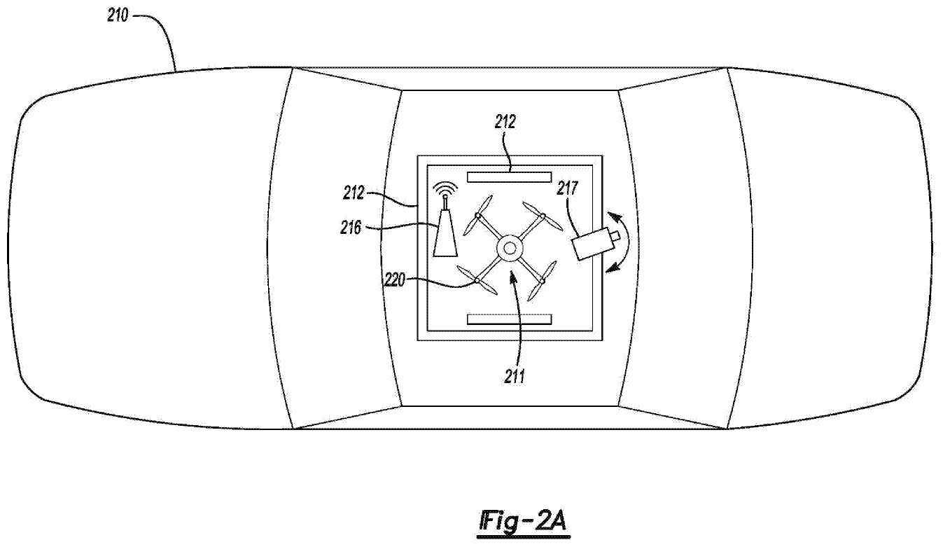

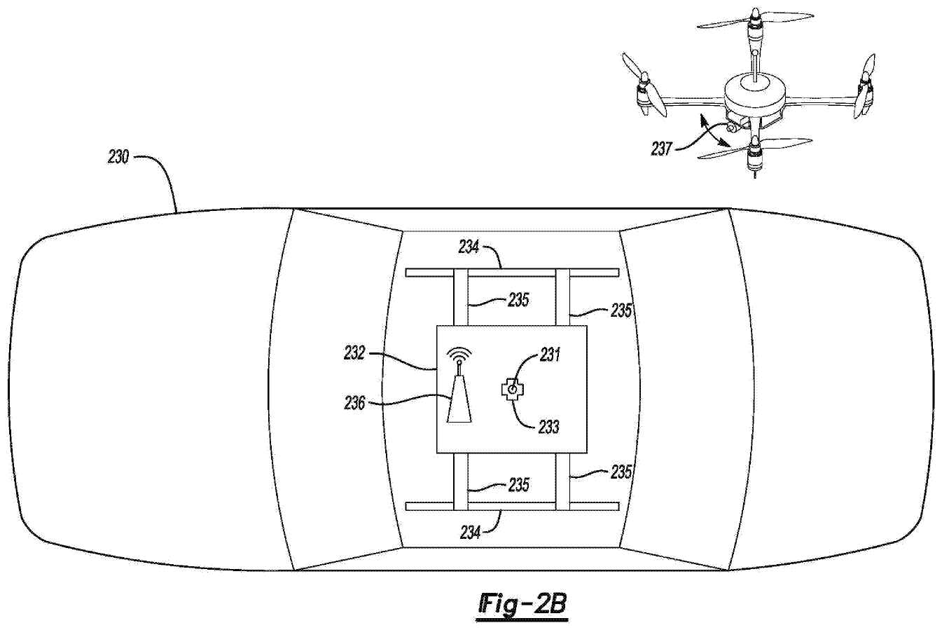

FIGS. 2A and 2B show illustrations of drone landings according to aspects exemplary embodiments.

Referring to FIG. 2A, an example of a vehicle 210 that includes a landing point 211. In FIG. 2B, the landing point is on the roof area of the vehicle. However, in other examples, the landing point may be on the front hood area or rear trunk area of the vehicle. The landing point 211 may include a landing indicator 212 such as reflectors, markings or lights. The landing indicator 212 may be reflective or illuminated and may be used by the drone to determine position and bounds of the landing point.

The landing point 211 may include one or more from among a beacon 216 or a camera 217. The beacon 216 may emit a signal that can be used by drone 220 to locate the landing point 211 and position the drone 220 over the landing point 211 and land at the landing point 211. Similarly, the camera 217 may provide image information to the drone or may be used to determine the position of the drone by the vehicle and assist the drone by providing landing instructions from the vehicle. Examples of landing instructions may include instructions to move left, right, up or down or instructions to speed up or slow down.

Referring to FIG. 2B, another example of a vehicle 230 that includes a movable landing point 232. The movable landing point 232 may include tracks or rails 234, 235 along which the movable land point 232 is configured to slide or move. In the example shown in FIG. 2B, the movable landing point 232 is configured to move, slide, roll left to right along tracks/rails 235. In addition, tracks/rails 235 are configured to move forward/backward along tracks/rails 234, thereby moving the movable landing point 232 forward and backward. The system shown in FIG. 2B may include camera 217 (not shown) as well to provide necessary information to align movable landing point with the drone.

In one example shown in FIG. 2B, a marking 233 marks the center of landing point and may be used by the drone to center the on the landing point and land without the use of bounding marks. In addition, a latching device 231 may be used to capture or lock the drone to the landing point. The latching device 231 may be a magnetic latch and/or may be movable in any direction or may extend in any direction. For example, the latching device 231 may extend or move up, down, left, or right. In another example, the latching device 231 may include a magnetic latch such that the magnetic latch would be activated/deactivated in the vehicle. The activation/deactivation of the magnetic latch may initiated by the position of the drone, the position of the drone with respect to the vehicle, the distance from the vehicle, etc.

The latching device 231 may latch to the underside of the drone. In one example, it may latch to one or more feet or supports of the drone or to the underside of the drone. Specifically, there may be one or more magnetic latches or other types of latches on the platform that are disposed at positions on the platform corresponding to the latch points on the drone. In another example, the latches may be movable, e.g., rotate, along the platform so as to line up with the latch points on the drone. In yet another example, the latches may be arranged in a circular array which is switched on to latch in multiple positions.

The drone in FIG. 2B also includes a camera 237, which may be used to maneuver the drone. Further, beacon 236, similar to beacon 216 described above may signal the drone to help position it over the landing point 232.

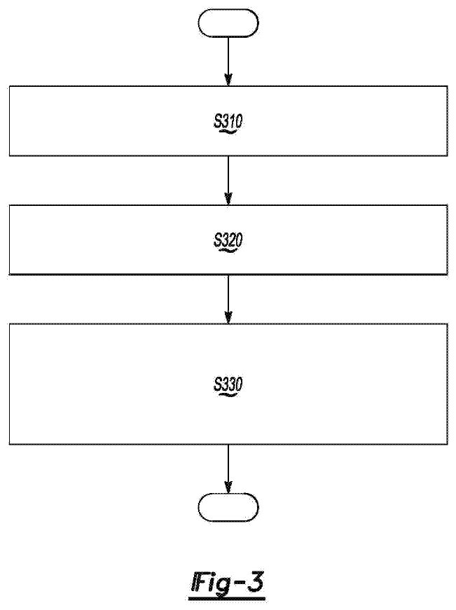

FIG. 3 shows a drone landing method according to an aspect of another exemplary embodiment.

Referring to FIG. 3, the speed and position of the vehicle is determined based on vehicle information in operation S310. The vehicle information may be information from sensors of the vehicle received by the drone via a communication device.

In operation S320, the drone may maneuver itself above the landing point on the vehicle based on the vehicle information and speed and position information of the drone. For example, the drone can adjust its speed, altitude, and position based on the vehicle information. In addition, the drone can synchronize its speed with the speed of the vehicle.

In operation S330, the drone is landed at the landing point by tracking the landing point based on one or more images provided by a camera at the drone, moving the landing point to catch or capture the drone, and controlling the drone to position it at the landing point based on a signal output by a beacon the vehicle.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A drone landing method, the method comprising:
determining a position and a speed of a vehicle based on vehicle information received via wireless communication;
maneuvering a drone to a position above a landing point on the vehicle based on the vehicle information and synchronizing the speed of the drone to the speed of the vehicle; and
landing the drone at the landing point of the vehicle.

2. The method of claim 1, further comprising receiving the vehicle information from the vehicle via one or more from among cellular, Wi-Fi and Bluetooth Communication,
wherein the vehicle information is information provided by one or more from among an inertial measurement unit, a global positioning device at the vehicle, a speedometer at the vehicle, and a speed sensor at the vehicle.

3. The method of claim 1, wherein the landing the drone comprises tracking the landing point of the vehicle via an image taken by a camera at the drone and landing the drone based on the tracking.

4. The method of claim 3, wherein the landing point comprises a symbol to be tracked by the drone.

5. The method of claim 3, wherein the landing point comprises one or more landing indicators, from among a lighted pattern, a programmed lighting sequence or configuration, and a reflector, to be tracked by the drone during the landing.

6. The method of claim 1, wherein the landing the drone comprises receiving a signal at the drone emitted by a beacon at the vehicle, determining the landing point of the vehicle via the signaling and landing the drone based on the signaling.

7. The method of claim 1, further comprising moving the landing point via a rail mechanism to catch the landing drone.

8. The method of claim 1, further comprising activating a latch to capture the drone.

9. The method of claim 1, further comprising storing the drone by activating a cover to cover the landing point or moving the landed drone into a drone storage location.

10. A non-transitory computer readable medium comprising instructions executable by a processor to perform the method of claim 1.

11. A drone landing drone system, the system comprising:
at least one memory comprising computer executable instructions; and
at least one processor configured to read and execute the computer executable instructions, the computer executable instructions causing the at least one processor to:
determine a position and a speed of a vehicle based on vehicle information received via wireless communication;
maneuver a drone to a position above a landing point on the vehicle based on the vehicle information and synchronize the speed of the drone to the speed of the vehicle; and
land the drone at the landing point of the vehicle.

12. The system of claim 11, further comprising a communication device,
wherein communication device is configured to transmit the vehicle information from the vehicle, and
wherein the vehicle information is information provided by one or more from among an inertial measurement unit, a global positioning device at the vehicle, a speedometer at the vehicle, and a speed sensor at the vehicle.

13. The system of claim 11, wherein the controller is further configured to land the drone by tracking the landing point of the vehicle via an image taken by a camera at the drone and landing the drone based on the tracking.

14. The system of claim 13, wherein the landing point comprises a symbol to be tracked by the drone.

15. The system of claim 13, wherein the landing point comprises one or more landing indicators, from among a lighted pattern, a programmed lighting sequence or configuration, and a reflector, to be tracked by the drone during the landing.

16. The system of claim 11, further comprising a beacon at the vehicle configured to emit a signal that is detectable by the drone,
wherein the controller is configured to determine the landing point of the vehicle based on the signal emitted by the beacon and control to land the drone based on the signaling.

17. The system of claim 11, wherein the landing point comprises tracks or rails configured to move the landing point forward, backward, left and right with respect to the vehicle.

18. The system of claim 11, wherein the landing point comprises a latch configured to latch onto the drone as it is landing.

19. The system of claim 18, wherein the latch comprises a rotating magnetic latch.

20. The system of claim 11, wherein the controller is further configured to control to store the drone by activating a cover to cover the landing point or control to move the landed drone into a drone storage location.
